(19) United States
(12) Patent Application Publication
(10) Pub. No.: US 2021/0183345 A1
(43) Pub. Date: Jun. 17, 2021

(54) PORTABLE DEVICE TO LIMIT UNWANTED MOVEMENT OF DRUMS AND OTHER MUSICAL INSTRUMENTS

(71) Applicants: William James Butera, Gladwyne, PA (US); Joseph Fabbri Butera, Gladwyne, PA (US)

(72) Inventors: William James Butera, Gladwyne, PA (US); Joseph Fabbri Butera, Gladwyne, PA (US)

(21) Appl. No.: 16/798,364

(22) Filed: Feb. 22, 2020

Related U.S. Application Data
(60) Provisional application No. 62/960,672, filed on Jan. 13, 2020.
(60) Provisional application No. 62/947,574, filed on Dec. 13, 2019.

(51) Int. Cl. G10D 13/10

(52) U.S. Cl. CPC G10D 13/28

(57) ABSTRACT

A portable musical instrument blocking device (1) to limit unwanted movement of a musical instrument during use. The blocking device engages said musical instrument's forward-facing leading edge where kinetic energy of the musical instrument's forward motion is transferred to the main body (2). A gripping material (10) on the blocking device's downward-facing surface grips the floor surface (9) and thereby limits movement on the floor plane. Engagement between the blocking device and the musical instrument is such that kinetic energy of the musical instrument's upward motion is not substantially transferred to the blocking device. The blocking device can be easily detached from the floor surface with application of manual force in the upward direction.

### CROSS-REFERENCE TO RELATED APPLICATIONS

This application claims priority to and the benefit of U.S. Provisional Application Ser. No. 62/960,672 Filing Date or Jan. 13, 2020 by William James Butera and Joseph Fabbri Butera titled “A vibration-absorbing device to stop unwanted movement of objects during use for objects with curved, straight, or irregular leading edges” which prior application is incorporated by reference herein in its entirety and made part hereof.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

The inventors represent that they have made prior disclosures of some of the concepts claimed in this application but such disclosures were made solely by the inventors and within the grace period provided in AIA 35 U.S.C. 102(a)(1).

### BACKGROUND OF THE INVENTION

When drums and many other musical instruments are played, it is optimal for the musical instrument and its components to stay stationary. However, during use, musicians must apply considerable force to the instrument, which can cause the instrument to move in unwanted directions. For example the bass drum of an acoustic drum set or on an electronic drum set will slide away from the drummer when it is struck by the pedal-operated beater applying percussive force in the forward direction. Similarly, the pedal activated hi-hat cymbal stand will also slide away from the drummer when it is played because of the forward-directed forces applied to the pedal. For keyboards and electric pianos, the pedals sit freely on the ground beneath the instrument and slide around the floor plane when the keyboardist's foot applies pressure to the pedal.

This unwanted movement of the musical instruments is a problem for musicians. Musicians all have unique and varied requirements for positioning their instruments based on physique, style of play, and personal preferences. Because musicians depend on muscle memory in order to consistently play their instruments, when the position of their instrument shifts during a performance, their ability to play is impaired, and the quality and sound of their performance is diminished. It is also disruptive for the musician to have to attempt to reconfigure their instrument setup during a performance.

An existing method for mitigating unwanted movement of musical instruments is by placing heavy objects such as concrete cinder blocks, sand bags, lead weights, etc. in front of the musical instrument. However, such method has numerous drawbacks for the musician. The objects are extremely heavy, difficult to transport, hard to move or reposition, and they are unsightly in a performance setting. A common hollow cinder block for example is 8×8×16″ and weighs approximately 35 pounds. And we have noticed that one cinder block is not adequate to stabilize a drum set. This is because the amount of resistance to movement along the floor plane which can be created by a pound of downward-pressing weight is minimal in relation to that weight. A drummer would have to carry multiple cinder blocks to adequately secure their instruments. Clearly this is not practical. And the risk of personal injury to the drummer from carrying, setting up, and transporting such heavy objects is a concern.

It should be noted that in the music field, portability of equipment is important to musicians because they need to frequently move their equipment from one venue or location to another and this requires the musician to often carry all of their own equipment in and out of buildings and into vehicles for transport. Musicians may need to carry in, set up, play, tear down, carry out, and transport their equipment multiple times in one day. So large, heavy devices such as concrete blocks and sand bags are not practical gear for most musicians.

Other existing attempts to limit the unwanted movement of musical instruments have been devices which attach directly to the musical instruments or to appendages of the musical instruments in an attempt to anchor the instruments. However, we have noticed that the effectiveness of these devices is less than optimal precisely because said anchoring devices are attached to the very moving instrument which they are trying to stabilize. This attachment of the device to the instrument or its appendages means that the devices are subject to all of the vibrations, bouncing, rebounding, and chaotic forces of the musical instrument itself. Such bouncing and rebounding forces inevitably include upward forces and motion which tend to unweight and uplift the anchoring device and as such cause it to loosen or detach its grip on the floor and thus allow the device and hence the instrument to move in unwanted directions. In the case of the pedal-activated bass drum, we have observed that anchoring devices mounted onto either the drum rim hoops or onto appendages such as drum spurs experience the aforementioned uplifting problem and tend to lose their grip on floor surfaces resulting in unwanted movement across the floor plane.

It should be noted that the forces and motions caused by operation of musical instruments, are often complex, multi-vectored, chaotic and somewhat unpredictable. For example, when a bass drum pedal is activated by the musician, the pedal is pressed down which causes a rebounding effect upwards, a deformation of the drum hoops and shell and heads with multi-vectored ramifications, at the same time, when the pedal is depressed, the beater head is caused to move rapidly upwards and forwards. Similarly the operation of the hi-hat cymbal system has multi-vectored motions and forces including substantial upward forces when the spring-loaded system springs the cymbal upwards after closure. For these reasons, devices mounted directly to the instruments they are trying to secure will tend to be dislodged from the floor and hence will allow unwanted movement of the musical instruments.

We have also noticed that devices mounted directly onto the musical instruments can damage the surface of the instrument, such as the wood hoops of the bass drum, and for this reason musicians may tend to avoid such devices.

Another existing attempt to stop unwanted movement of musical instruments, in the case of drums, has been to permanently or semi-permanently mount solid blocks onto existing floors or floor coverings. A drummer could, for example, attach a solid board to a stage floor using nails, screws, or bolts. Such an approach is impractical for most drummers because it cannot be easily removed and reinstalled in various locations as the drummer travels. Moreover the nails, screws and bolts would permanently damage the flooring leaving holes and splinters, much to the consternation of venue owners and other performers subsequently using the venue. Also such approach requires hard dense boards as curb materials such as wood in order to withstand the concentrated forces bearing on the penetrations, screws, nails, and bolts. As such, this approach cannot be used with blocking material that has pliable, malleable, shock-absorbing properties as may be desirable for reducing vibration, dissipating energy, and minimizing rebound of percussive forces.

Also, if such boards are permanently affixed to a floor covering such as carpeting or rugs, the system would then include the entire floor covering as well and the affixed boards. This would make the system heavy, bulky, more difficult to transfort, and generally non-portable. Also such a system would not permit relocation of the affixed board on the floor-covering material so the musician would be confined to one predetermined setup of their instruments. Because the spacing on instrument components, such as the spacing between the bass drum and hi-hat cymbal stand vary infinitely between drummers based on physique, size, method of playing, and personal preference, any system having boards permanently affixed could not fit all drummers and would hence have commercial disadvantage.

Another existing method attempting to stop unwanted movement of drums is a device to tie the bass drum to the musician's seat using ropes, strings or straps. We have observed several problems with this approach. First, it creates a tripping hazard to have ropes, strings, or straps strung above the floor between the bass drum and the drummer's seat. This area is exactly where drummers must walk to position themselves, often at high speed, when approaching or exiting the drum set. Second, during the course of a performance, drummers often need to reposition their seat for comfort, to adjust their position based on the music, and other reasons. If the bass drum is tethered to the seat, any repositioning of the seat will inevitably cause the bass drum to move and changes its position relative to the rest of the drum set. When this happens, the drummer would need to reposition the enter drum set or to try and adjust to the altered set up and relative positions of the drum set components.

### BRIEF SUMMARY OF THE INVENTION

The present invention relates to the field of musical instruments. More specifically this invention relates to devices for stabilizing musical instruments while playing.

It is an objective of the present invention to create a lightweight, compact, portable, independent barrier, not attached to the moving musical instrument, not subject to transfer of the upward motion and upward forces of the musical instrument, which can be easily and quickly installed and uninstalled and which can thus better prevent the musical instrument from moving on the floor plane in a wide variety of locations and situations.

In accordance with one embodiment, a musical instrument blocking device comprising a main body capable of dissipating and/or transferring kinetic energy from a rear-facing surface capable of receiving kinetic energy from various musical instruments and dissipating or transferring said energy to a downward-facing surface with means for gripping the floor surface through mechanical means, molecular attraction, or other adhesive properties.

Accordingly some embodiments provide advantages of one or more aspects as follow: To restrict unwanted movement of drums and other musical instruments and components along the floor plane during use, in a way that will not disengage said instrument due to it's vibrations or varying motions including vertical motions, that does not restrict the ability of the musician to move about the instrument or to move their chair when seated, that is easy to set up, that can attach and detach quickly from floor surfaces, that is lightweight, that is compact, that is easy to transport, that is versatile and useable with various instruments, that is shock-absorbing, that does not provide kickback, that won't damage the instrument, that won't damage the floor when installed, that is space efficient, that is safe, that does not use ropes or other potential hazards, that is silent, that has no moving parts, that does not need tools or assembly, that can be used on variously shaped instruments. Other advantages of one or more aspects will be apparent from a consideration of the drawings and ensuing description.

The downward-facing gripping surface grabs onto the floor or floor covering surface, greatly restricting unwanted motion of the instrument along the floor plane. Attaching to the floor makes the musical instrument blocking device independent from the movement, vibrations, and bouncing of the musical instrument. It also allows the musical instrument blocking device to work equally on a multitude of instruments of varying shapes, sizes, and weights. The rear-facing surface receives the kinetic energy from the forward motion of the musical instrument and transfers said energy to the downward-facing gripping surface. Said rear-facing surface does not, however, transfer any substantial amount of upwardly-directed kinetic energy or the upward motion of the musical instrument.

### BRIEF DESCRIPTION OF THE SEVERAL VIEWS OF THE DRAWINGS

FIG. 1 shows various aspects of the musical instrument blocking device in accordance with one embodiment.

FIG. 2 shows aspects of the rear-facing planar surface, the downward-facing surface, the protruding edges, and the hook grip material on the downward-facing surface as proposed in one embodiment.

FIG. 3 shows perspectives of one embodiment including the protruding edge, the rear-facing planar surface, the hooked gripping material, the passage tunnel inlet and outlet.

FIG. 4 shows aspects of one embodiment of the musical instrument blocking device placed on the floor surface in front of an acoustic bass drum.

FIG. 5 shows another embodiment including the v-shaped rear-facing surface nearing the curved leading edge of a musical instrument pedal.

FIG. 6 Shows additional aspects of another embodiment with the v-shaped rear-facing surface in contact with the curved leading edge of a musical instrument pedal.

FIG. 7 shows another embodiment with an inclined rear-facing surface, a planar rear-facing surface perpendicular to the bottom-facing surface, and gripping material on the downward-facing surface.

### DETAILED DESCRIPTION OF THE INVENTION

In the following detailed description, certain specific terminology will be employed and certain concepts will be referenced for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

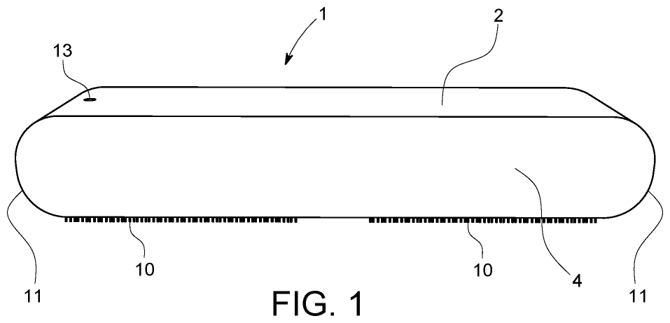

One embodiment of the musical instrument blocking device is shown in FIG. 1. The musical instrument blocking device 1 has a main body 2 which in one embodiment can be a malleable shock-absorbing material such as but not limited to rubber or EVA foam with structure and firmness sufficient to <absorb, dissipate, or otherwise> transfer kinetic energy. In this embodiment the planar rear-facing surface 4 rises perpendicularly from the bottom-facing surface 3.

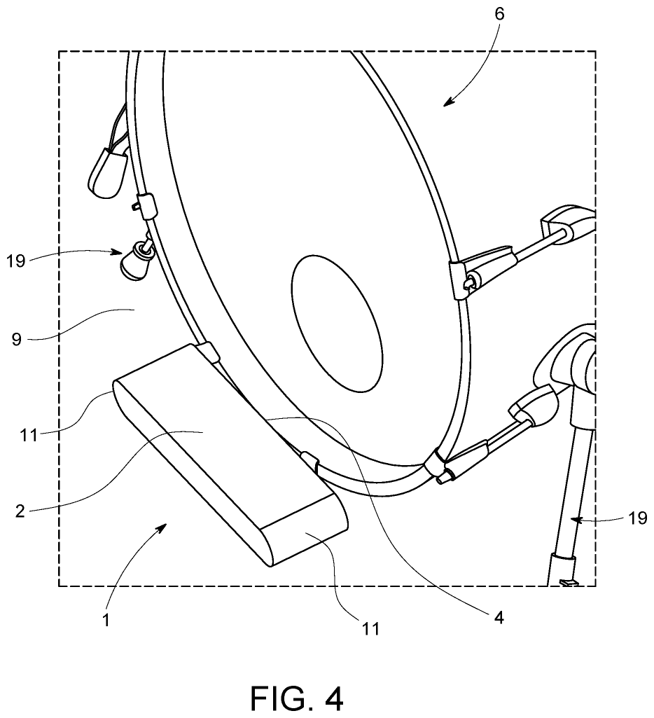

The dimensions of the planar rear-facing surface are sufficient in height to contact and engage with the intended musical instrument. The dimensions of the rear-facing surface are also sufficient in width to engage multiple points of contact with the intended musical instrument (See FIG. 4).

In one embodiment envisioned here, the dimensions of the planar rear-facing surface are 279 mm by 47 mm. The dimensions of the downward-facing surface on this embodiment are 87 mm by 250 mm.

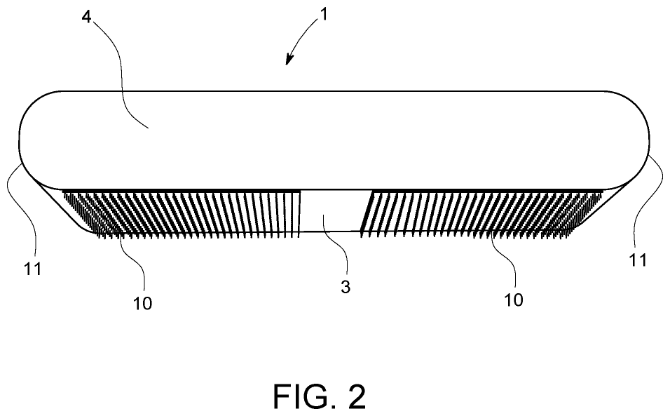

FIG. 2 shows one embodiment in which the gripping material 10 extends from or is mounted onto the downward-facing surface 3. In this embodiment the gripping material could be, but is not limited to, a plurality of flexible hooks such as the hooks in hook and loop material. The hooks should be sufficient in number to create adequate resistance to movement along the floor plane. The number of hooks on the downward-facing surface of the embodiment envisioned here is approximately 7,000 hooks.

FIG. 1 shows one embodiment in which one or more of the sides (non rear-facing or downward facing surfaces) have protruding surfaces 11.

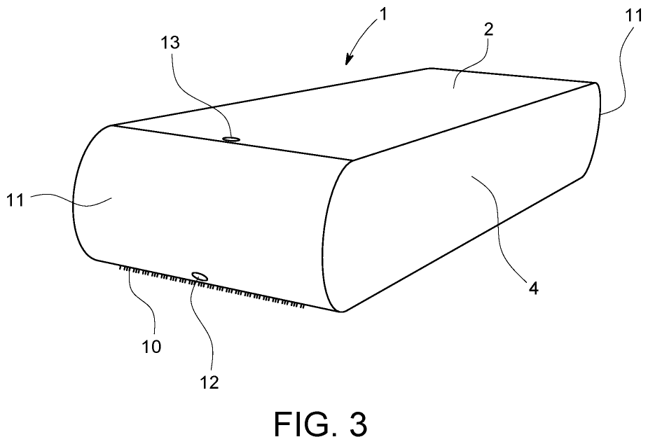

FIG. 3 shows one embodiment in which a tunnel comprising an inlet 13 on one surface of the body and an outlet 12 on another surface of the body are located as to not interfere with the gripping material 10 of the downward facing surface, or with any rear-facing surface 4.

In operation, the musical instrument blocking device is positioned forward of the musical instrument and in contact with the forward-facing leading edge of the musical instrument. The planar rear-facing surface 4 engages the forward-facing edge of the musical instrument. The planar rear-facing surface provides multiple points of contact when engaging with a musical instrument such as a bass drum 6 as shown in FIG. 4.

The gripping material 10 of the downward-facing surface 3 engages with the floor surface or floor covering 9. It should be noted that in this description and throughout this entire disclosure, any reference to the “floor” or “floor surface” is deemed to include floor-covering materials such as, but not limited to those carpets, rugs, mats, laminates, etc. which may be compatible for engagement with the gripping material of the device.

The gripping material 10 is pressed onto a compatible floor surface 9 so as to engage with said floor surface. In one embodiment the gripping material 10 is the hook gripping material of a hook and loop type system. Such hooks can grip many floor covering materials and, when engaged in sufficient numbers, can resist movement along the floor plane. Such hooks, when configured as described in this embodiment, can offer substantial resistance to movement across the floor plane, can be quickly attached to the floor surface with downward pressure to cause engagement, and subsequently be quickly detached from the floor surface with manually applied upward force. Thus the gripping material described in this embodiment allows the musical instrument blocking device to be quickly placed, and easily removed for transport or for repositioning.

The gripping force of such hooks can easily be engaged with and thus attached to the floor covering materials and the material can be disengaged from the floor covering materials when upward force is applied in a direction perpendicular or roughly perpendicular to the downward-facing surface.

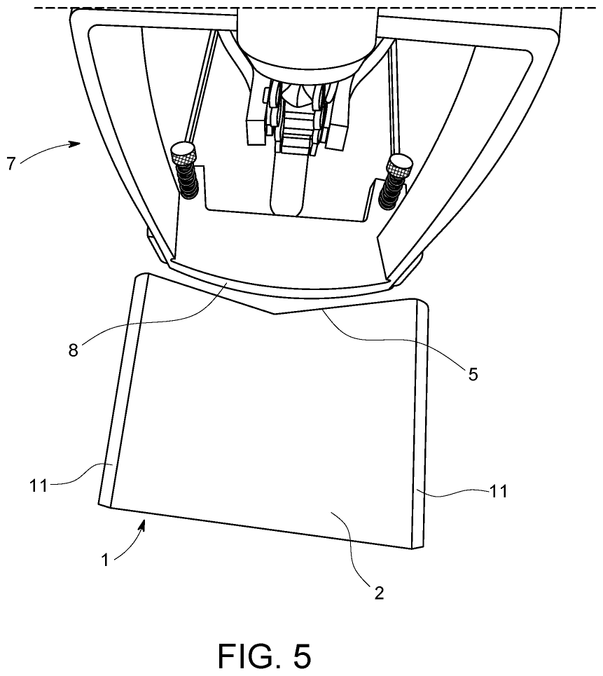

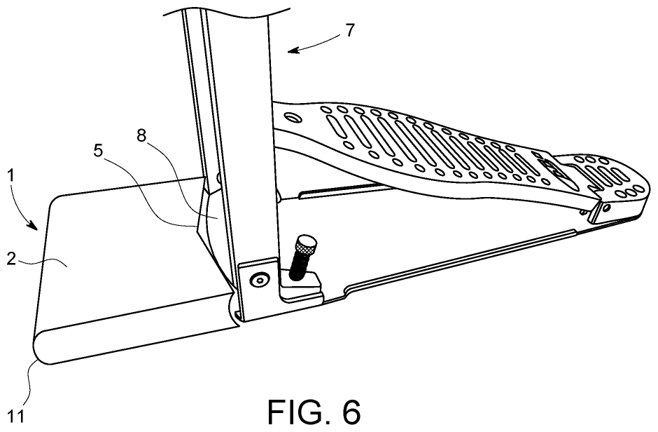

To facilitate detachment of the device and disengagement of gripping material from the floor surface 9, some embodiments may include a protruding surface 11 or a concavity sufficient to provide means for the user to insert fingers and apply manual force in the upward direction so as to disengage the gripping material from the floor surface. Embodiments shown in FIG. 1, FIG. 2, FIG. 3, FIG. 4, FIG. 5, and FIG. 6 show examples of such protruding surfaces 11.

To prevent loss during transportation, and loss due to separation from the musical instrument between uses, a string or chain or other cable (not shown) can be added by means of the tunnel inlet 13 and outlet 12 shown in FIG. 3. Such string or chain or cable can be secured to the musical instrument blocking device and further secured to the musical instrument or other objects thus rendering the objects inseparable. Such string, chain, or cable can also be pulled upward by the user so as to apply upward force to one end of the device so as to facilitate application of manual force to disengage the gripping material 10 and detach the device from the floor covering.

Another embodiment of the musical instrument blocking device 1 is one with a V-shaped rear-facing surface 5, as seen in FIG. 5 and FIG. 6. This embodiment, comprising the main body 2, hook gripping material 10, protruding surfaces 11, 11a, and V-shaped rear-facing surface 5, facilitates engagement with curved and irregular shaped musical instruments, for example a hi-hat stand and pedal 7 by creating a plurality of points of contact between the V-shaped rear-facing surface 5 and such musical instrument pedal. This embodiment is positioned forward of the musical instrument and in contact with the forward-facing leading edge of the musical instrument. The V-shaped rear-facing surface 5 engages the curved forward-facing edge of the musical instrument 8. The gripping material 10 of the downward-facing surface 3 engages with the floor surface or floor covering 9. FIG. 5 and FIG. 6 illustrate how the V-shaped rear-facing surface will engage at multiple points the curved leading edge 8 of a musical instrument pedal 7. If this were a planar rear-facing surface engaging with the curved leading edge of a musical instrument, there would be only one tangential point of contact and said musical instrument would have the opportunity to pivot and would not be secure. The multiple points of contact ensure stability and prevent the curved musical instrument from pivoting and sliding.

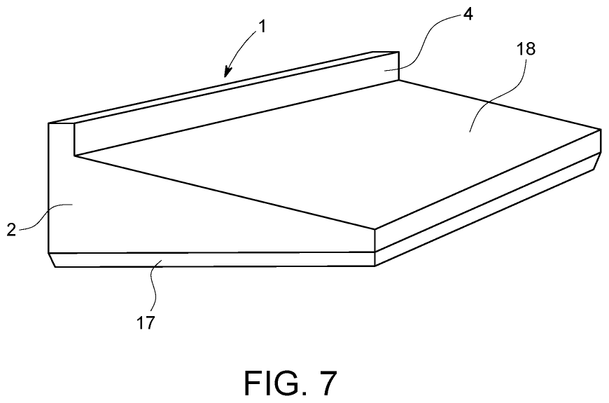

Another embodiment of the musical instrument blocking device 1 is one with a downward-facing surface 3 comprising a material 17 which creates substantial adhesive friction between downward facing surface's gripping material and the floor surface. This embodiment, shown in FIG. 7, comprising the main body 2, an inclined rear-facing surface 18 leading to a planar ear-facing surface 4, and the downward-facing surface 3 with an adhesive gripping surface 17. Said embodiment is designed for hard floor surfaces such as, but not limited to, cement, tile, wood. Said embodiment is placed on the floor surface 9. The intended musical instrument is then placed onto the inclined rear-facing surface 18 with the forward-facing leading edge engaging the planar rear-facing surface 4. The force created by playing the instrument will be transferred to planar 4 and inclined rear-facing surface 18, and exerted as downward pressure further securing the adhesive bond between the downward-facing surface and the floor surface. Materials which could provide the type of adhesive friction envisioned in this embodiment may include, but are not limited to, certain types of rubber, certain “sticky” polymers, and certain adhesive coatings with properties similar to 3M Company's Post-It adhesive. These materials and coatings offer induce substantial friction when moved across a plane yet are easily detached when lifted upwards away from said plane.

In some embodiments, the material comprising the main body can have, but is not required to have, properties which provide pliable deformation such that the material conforms more closely the shape of the musical instrument thus increasing the number of points of contact and the surface area of engagement between the rear-facing surface and the musical instrument so as to facilitate energy transfer from the musical instrument to the main body.—which can dissipate and transfer kinetic energy from the musical instrument engaged with the rear-facing surface 4.

Thus the reader will see that one or more embodiments of the musical instrument blocking device provides a more portable, more compact, lighter weight, more secure, easier to use, and faster way to secure a wide variety of musical instruments during use.

Furthermore, the musical instrument blocking device of one or more of the embodiments provides substantial advantages for musicians in that they:
Permit fast setup and tear down of the musician's equipment
Allow the device to be quickly detached and reattached to the floor surface so as to reposition the device and the musical instrument
Allow the musician to easily carry and transport the musical instrument blocking device from place to place due to the device's lightweight and small size
Provide handles in the form of protruding surfaces or concavities to facilitate quick and easy manual detachment of the device from the floor surface.
Permit use of musical instruments with varying shapes and curvatures
Permit use on a variety of floor surfaces
Provide a blocking device which opposes and limits the musical instrument's forward movement yet is not subject to the instrument's bouncing up and down movement which upward movement could tend to detach the blocking device from the floor surface.
Can absorb and dissipate unwanted kinetic energy of the musical instrument
Insure the secured positioning of the musical instrument
Provide a barrier to limit the instrument's movement that will not cause kinetic energy to bounce back to the player, which has to potential to cause bodily harm
Engage the musical instrument without causing damage to said instrument
Allows the musical instrument blocking device to substantially grip the floor surface without marking, scratching or otherwise damaging said floor surface
Allows the musical instrument blocking device to substantially grip a variety of floor surface materials
Is not attached to the musician's chair nor dependent on the position of the musicians chair thus allowing the musician to relocate his or her chair without causing the musical instrument to shift its position
Provide a stationary body that Is not attached to any moving object and not attached to the musical instrument being secured.
Provide means for limiting unwanted movement which means are not dependent on weight in order to be effective such that in one embodiment the described blocking device with hook gripping material, while weighing just six ounces, the device can be more effective at limiting movement than 100 pounds of weighted objects.

While our above description contains many specificites, these should not be considered as limitations on the scope, but rather as exemplification of several embodiments thereof. Many other embodiments are possible. For example the rear facing surface could differ in size and shape, such as greater or lesser height, and greater or lesser width. The color of the musical instrument blocking device can vary based on consumer preference. Accordingly the scope should be determined not by the embodiments illustrated, but by the appended claims and their legal equivalents.

We claim:

1) A musical instrument blocking device comprising:
a) a body with a downward-facing surface and one or more rear-facing surfaces
b) Wherein said rear-facing surfaces of the body rise upward from and perpendicular to or at acute angles to the downward-facing surface
c) Wherein said rear-facing surfaces are sufficient in height and width to contact the intended musical instrument
d) Wherein said rear-facing surfaces are shaped or arranged in a manner to contact the intended musical instrument at a plurality of points of contact
e) Wherein the engagement between the rear-facing surface and the musical instrument provides means to substantially transfer kinetic energy from the forward motion of the musical instrument to the rear-facing surfaces and to said body without substantially transferring the kinetic energy of the upward motion of the musical instrument
f) Wherein the material substance or structure of said body provides means for transferring kinetic energy from the rear-facing surfaces to the downward-facing surface of said body.
g) Means for said downward-facing surface of said body to grip a floor surface or floor covering material by means such as but not limited to friction, adhesion, molecular attraction, suction, or mechanical engagement wherein said grip prevents or inhibits unwanted movement of the musical instrument blocking device along the floor plane
h) Wherein said grip between the downward-facing surface of said body and the floor surface or floor covering material can be disbanded and disengaged by application of upward force to the body so as to dislodge the downward-facing surface from the floor surface and hence detach the device
Whereby said musical instrument blocking device limits unwanted motion of the musical instrument along the floor plane and can be attached and detached from floor surfaces as needed.

2) The musical instrument blocking device in claim 1 wherein said downward-facing surface comprising a plurality hooks and the hook material of a hook and loop system sufficient to grip certain floor surfaces and floor covering materials and thus limit movement of the downward-facing surface along the floor plane

3) The musical instrument blocking device in claim 1 wherein the downward-facing surface comprises an adhesive material with properties such that the molecular attraction causes the downward-facing surface to adhere to the floor surface so as to resist movement across the floor plane.

4) The musical instrument blocking device in claim 3 wherein the molecular attraction of the adhesive material causes the downward-facing surface to resist movement across the floor plane while offering substantially less resistance to upward movement away from the floor plane.

5) The musical instrument blocking device in claim 1 wherein the downward-facing surface provides means for mechanically inducing friction between the downward-facing surface and the floor surface in order to restrict movement of the downward-facing surface along the floor surface.

6) The musical instrument blocking device in claim 1 wherein the body material or structure provides means for vibration-absorbing with means to dissipate forces and kinetic energy received from the musical instrument and means to transfer those forces and kinetic energy which cannot be dissipated.

7) The musical instrument blocking device in claim 1 wherein the shape of said body includes one or more protruding surfaces or convex features sufficient to enable the user to manually grasp the body and exert an upwards force and thus disband the bond between the the downward-facing surface of said body and the floor surface.

8) The musical instrument blocking device in claim 1 wherein the shape of said body includes one or more concavities sufficient to enable the user to manually grasp and exert an upwards force and thus break the bond between the downward-facing surface of said body and the floor surface.

9) The musical instrument blocking device in claim 1 wherein the the rear-facing surfaces consist of two or more planes in a V-shaped formation or otherwise angled in relation to each other such that when said planes contact curved or irregular surfaces of musical instruments, engagement is attained at a plurality of points of contact

10) The musical instrument blocking device in claim 1 wherein the rear-facing surface is planar to more securely engage with musical instruments where preferred points of contact are aligned on one plane.

11) The musical instrument blocking device in claim 1 wherein the substance of the body is sufficiently malleable so as to provide means for said body to conform to the shape and substantially retain the shape of the musical instrument and thereby expand the number of points of contact and increase engagement between the rear-facing surfaces and the musical instrument.

12) The musical instrument blocking device in claim 1 further comprising a hole through the body and a string or chain attached through said hole with means to link the musical instrument blocking device to the musical instrument or to other objects such as backpacks, musical instrument carrying cases, musical instrument stands wherein such string can also be used to exert manual upward force on the body to assist in detaching the device from the floor surface.

13) The musical instrument blocking device in claim 1 wherein a portion of the rear-facing surface is inclined at an acute angle relative to the downward-facing surface thereby providing means to enhance the transfer of kinetic energy of forward motion into downward forces as means for increasing the grip between the downward-facing surface and the floor surface.

14) A method of limiting unwanted motion of a musical instrument along the floor plane when said instrument is being played comprising the downward-facing surface of a body with one or more rear-facing surfaces rising upwards from and perpendicular to or at acute angles to the downward-facing surface with said rear-facing surface or surfaces contacting the musical instrument at one or more points of contact and transferring the kinetic energy of the forward moving musical instrument to the body and further transferring such energy to the body's downward-facing surfaces which has means for gripping the floor surface by means such as but not limited to friction, suction, molecular attraction, adhesion, or mechanical means engaging the floor surfaces and with certain features of said body protruding outward from said forming handles or with concavities facilitating manual uplifting of the body and thus facilitating disengaging the device from floor surfaces as needed.
